(19) United States
(12) Patent Application Publication
(10) Pub. No.: US 2007/0176555 A1
(43) Pub. Date: Aug. 2, 2007

(54) Electroluminescence panel

(75) Inventor: Noriaki Satomi, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/652,024

(22) Filed: Jan. 11, 2007

(30) Foreign Application Priority Data
Jan. 31, 2006 (JP) P2006-023606

(51) Int. Cl. H05B 33/04

(52) U.S. Cl. 313/512; 313/506

(57) ABSTRACT

An EL panel which can retard the advance of external components more in a resin is provided. An EL panel 10 in accordance with the present invention comprises a substrate 12, an EL device 14 formed on the substrate 12, a sealing plate 16 facing the substrate 12 and covering the EL device 14 on the substrate 12, and a resin 20 interposed between the substrate 12 and sealing plate 16 and added a filler 22, wherein a predetermined cross section of the filler 22 forms a non-closed shape including a curved part 22a. Therefore, in the EL panel 10, an external component reaching the curved part 22a of the filler 22 by advancing through the resin 20 retracts along the curved part 22a in order to bypass the filler 22. The retraction of external components greatly extends their path. Consequently, the EL panel 10 in the present invention can retard the advance of external components in the resin 20 more than conventionally done.

### BACKGROUND OF THE INVENTION

1. Field of the Invention

The present invention relates to an electroluminescence panel.

2. Related Background Art

EL (Electro Luminescence) devices such as organic and inorganic EL devices are light-emitting devices of self-emission type, which are characterized in that they are easy to reduce their size and weight while having a high luminance, and thus are expected to be employed in displays, illuminations, and the like. However, light-emitting materials used in these EL devices are likely to be deteriorated by components such as water, CO₂, and O₂ (which will hereinafter be referred to as external components). This is one of causes preventing the devices from achieving a longer life. Therefore, an EL device has conventionally been used in the form of an EL panel sealing the EL device therein in order to make it less likely to come into contact with air.

Known as a mode of such sealing is hollow type sealing in which an EL device is arranged between a substrate and a sealing plate, while only the outer peripheral part is sealed with a sealant (adhesive) made of a resin or the like. Such a hollow type EL panel is disclosed in Japanese Patent Application Laid-Open No. 2005-91874 and the like. The adhesive of the EL panel disclosed in this publication is added a granular filler or laminar filler. The filler inhibits external components from advancing in the adhesive, so that the external components progress in a meandering manner through the adhesive, whereby the path of the external components is longer than that in the case where the external components advance linearly when the adhesive is not added a filler. The EL panel in the above publication thus retards the advance of external components in the adhesive, thereby elongating the life of the EL device and EL panel.

### SUMMARY OF THE INVENTION

There has been the following problem in the adhesive used in the above-mentioned EL panel. Namely, the added filler insufficiently retards the advance of external components, so that the EL panel fails to elongate its life sufficiently. Therefore, the inventors conducted diligent studies and, as a result, have newly found a technique which retards the advance of external components more effectively than conventionally done, thereby allowing the EL panel to realize a sufficiently longer life.

Namely, for overcoming the problem mentioned above, it is an object of the present invention to provide an EL panel which can retard the advance of external components more in the resin.

The EL panel in accordance with the present invention comprises a substrate, an EL device formed on the substrate, a sealing plate facing the substrate and covering the EL device on the substrate, and a resin having a filler added interposed between the substrate and sealing plate, wherein a predetermined cross section of the filler forms a non-closed shape including a curved part.

In this EL panel, external components reaching the curved part after progressing through the resin retract along the curved part in order to bypass the filler. The retraction of external components greatly elongates their path. Therefore, the EL panel in the present invention can retard the advance of external components more than the prior art in which the external components do not retract.

The filler may have a form including a part of a spherical shell. At least a part of the curved part of the filler may be shaped like a bowl. The filler may be shaped like a bowl as well.

### BRIEF DESCRIPTION OF THE DRAWINGS

FIG. 1 is a schematic view showing an EL panel in accordance with a first embodiment of the present invention;

In FIG. 2, part (a) is a perspective view showing a filler added to the adhesive shown in FIG. 1, and part (b) is a view showing a hollow sphere used for making the filler shown in part (a);

FIG. 3 is a view showing an advancing path of an external component in the adhesive of the EL panel shown in FIG. 1;

FIG. 4 is a view showing an advancing path of an external component in the case where a hollow sphere is added to a resin;

FIG. 5 is a schematic sectional view showing an EL panel in accordance with a second embodiment of the present invention;

FIG. 6 is a view showing an advancing path of an external component in the adhesive of the EL panel shown in FIG. 5;

FIG. 7 is a schematic sectional view showing an EL panel in accordance with a third embodiment of the present invention;

FIG. 8 is a view showing an advancing path of an external component in the adhesive of the EL panel shown in FIG. 7;

FIG. 9 is a view showing an EL panel in a different mode; and

FIG. 10 is a view showing an EL panel in a different mode.

### DESCRIPTION OF THE PREFERRED EMBODIMENTS

In the following, modes considered to be the best when carrying out the invention will be explained in detail with reference to the accompanying drawings. The same or equivalent constituents will be referred to with the same numerals without repeating their overlapping explanations if any.

### First Embodiment

An EL panel 10 in accordance with a first embodiment of the present invention comprises a substrate 12, an EL device 14, a sealing plate 16, and an adhesive 18.

This EL panel 10 can be employed in any of top emission and bottom emission types. When the EL panel 10 is used as a bottom emission type, at least the substrate 12 in the substrate 12 and sealing plate 16 is constructed by a light-transmitting plate. When the EL panel 10 is employed as a top emission type, on the other hand, at least the sealing plate 16 in the substrate 12 and sealing plate 16 is constructed by a light-transmitting plate. The light-transmitting plate has a light-transmitting property (or is transparent), and is made of glass, plastic, or other light-transmitting materials.

The EL device 14 is formed on the substrate 12, and has a multilayer structure in which an EL layer is held between a pair of electrode layers. The EL layer may be constituted by any of organic and inorganic EL materials. The sealing plate 16 is provided so as to face the EL device 14 side of the substrate 12 in parallel and cover the EL device 14 on the substrate 12.

The adhesive 18 is interposed between the substrate 12 and sealing plate 16 and completely fills the gap therebetween. Here, the EL device 14 is provided at a position inside of an end face 16a of the sealing plate 16 by a predetermined distance, whereby the end face 16a of the sealing plate 16, an end face 12a of the substrate 12, and an end face 18a of the adhesive 18 are exposed at an end face 10a of the EL panel 10, whereas the EL device 14 is not exposed.

The adhesive 18 is constructed by doping a resin 20 with fillers 22. The adhesive 18 is obtained by dispersing the fillers 22 into the resin 20 with a mixer and a roll. Epoxy resins, silicone resins, and the like can be used as the resin 20. Each filler 22 is a bowl-shaped filler constituted by inorganic glass shown in part (a) of FIG. 2, and is made by dividing (more specifically, pulverizing) a hollow sphere (spherical shell) 24 shown in part (b) of FIG. 2. Consequently, the filler 22 has a predetermined cross section (e.g., a cross section of the line I-I passing a center C (center of curvature) of the filler 22) forming a non-closed shape as a whole including a curved part 22a. Also, the filler 22 has a form having a part of the spherical shell.

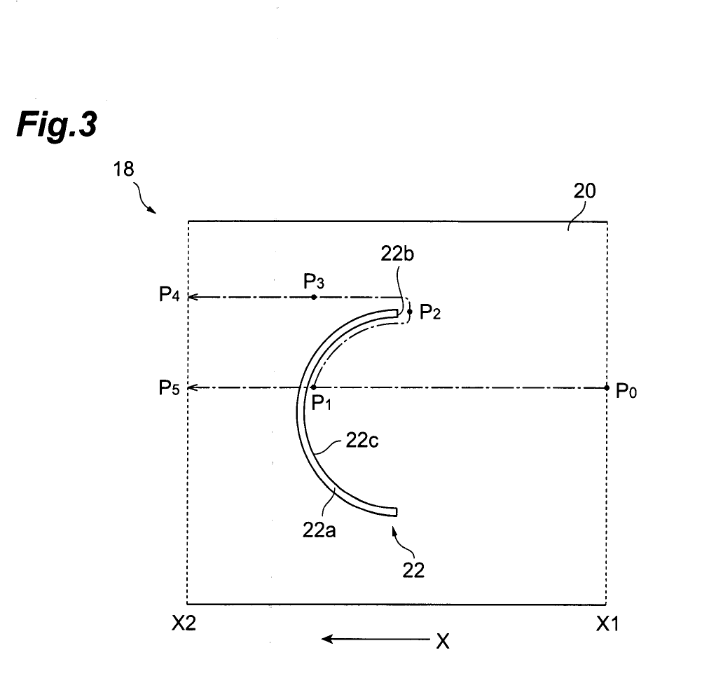

Each filler 22 in the adhesive 18 faces the end face 10a of the EL panel 10 (i.e., an edge 22b of the filler 22 is located on the end face 10a side of the EL panel 10), and inhibits external components from advancing in the adhesive 18. A mechanism by which the filler 22 intercepts an external component will now be explained with reference to FIG. 3. Specifically, a case where the external component progresses from a position X1 to a given position X2 along a direction X in the drawing (a direction orthogonal to the thickness of the adhesive 18 and to the end face 18a) in the adhesive 18 will be explained. The position X1 is the position of the end face 18a of the adhesive 18, for example, whereas the position X2 is a position inside of the end face 18a of the adhesive 18 by a predetermined distance, for example. The external components in this specification refer to water, CO₂, O₂, and the like, which adversely affect device characteristics of the EL device 14.

The external component advancing from a point P₀ of the position X1 in the X direction reaches a point P₁ in contact with the filler 22. At the point P₁, the external composition changes its advancing direction from the X direction to a direction extending to the edge 22b along the inner curved surface 22c of the filler 22 in order to bypass the filler 22. Upon arriving at the point P₂ of the edge 22b, the external component changes its advancing direction to the X direction again, thereby progressing toward a point P₄ of the position X2. Namely, when bypassing the filler 22 (i.e., when moving along the inner curved surface 22c of the filler 22), the external component moves in a retracting direction (or a direction neither advancing nor retracting) in terms of the X direction. Then, the external component is directed from the point P₂ to point P₄ while passing a point P₃ which is located at the same position as the point P₁ in terms of the X direction.

Therefore, the path of the external component is extended by the length of P₁-P₃ by way of the point P₂ as compared with the case without the filler 22 (i.e., the case where the external component advances straightforward from the point P₀ of the position X1 to a point P₅ of the position X2). The extended length P₁-P₃ exceeds 100 μm when a hollow sphere 24 of 50 μm is used for the filler 22, whereby the path is extended much more than in the prior art using a granular filler of about 1 μm or a laminar filler extending in the X direction (with a thickness of about 2 μm). Since the projected area of the filler 22 with respect to the advancing direction (X direction) of the external component is greater than that of the conventional granular or laminar filler, each filler has a wider region for intercepting the external component, thereby more effectively retarding the advance of the external component.

With respect to the advancing direction of the external component, the projected area of the hollow sphere 24 is on a par with that of the filler 22. However, the hollow sphere 24 does not contribute much to extending the path of the external component when added to the resin 20 as it is.

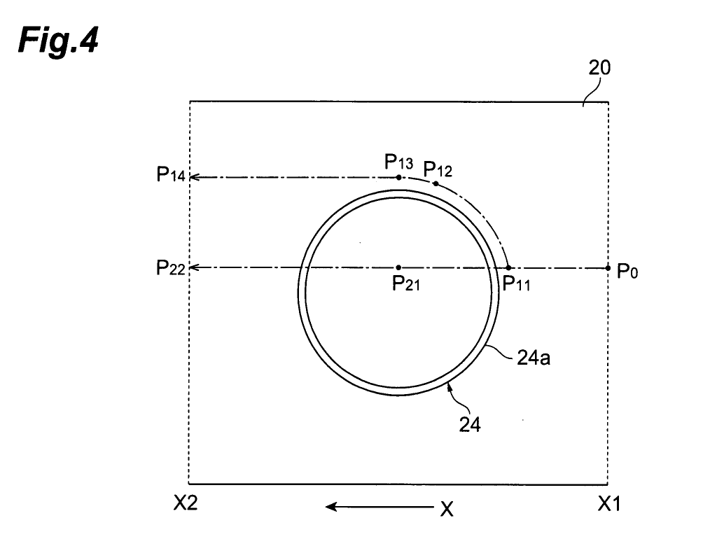

Namely, as shown in FIG. 4, the external component reaching a point P₁₁ in contact with the hollow sphere 24 after advancing in the X direction from the point P₀ of the position X1 detours along the outer curved surface 24a of the hollow sphere 24, and then changes the advancing direction again at a point P₁₃ of the upper end position to the X direction toward a point P₁₄ of the position X2. Thus, the external component does not retract in terms of the X direction in the case with the hollow sphere 24, so that the path is extended by only the length of P₁₂-P₁₃ as compared with the case without the hollow sphere (i.e., the case where the external component is directed from the point P₀ of the position X1 to a point P₂₂ of the position X2). Here, the point P₁₂ is a point separated from the point P₁₁ by the distance from the point P₁₁ to a point P₂₁ (at the same position as the point P₁₃ in terms of the X direction) along the outer curved surface 24a of the hollow sphere 24.

Therefore, the hollow sphere 24 having a circular cross section hardly extends the path of the external component when used as a filler as it is. By a similar reason, fillers having annular cross sections other than circular ones also hardly extend the path of external components.

As explained in detail in the foregoing, the EL panel 10 uses the adhesive 18 containing the filler 22 having a non-closed shape cross section including a curved part 22a, and thus greatly extends the path of external components as compared with the EL panels in accordance with the prior art. Therefore, the EL panel 10 can retard the advance of external components more in the resin 20, thereby realizing a longer life.

The filler 22 has such a cross sectional form (an arcuate cross section curved in the thickness direction of the adhesive 18) as to be able to buffer forces in the thickness direction of the adhesive 18. Therefore, the filler 22 is hard to break when coming into contact with the substrate 12 and sealing plate 16, and less likely to damage the EL device 14 when in contact therewith. Consequently, the filler 22 may have a size on a par with the distance between the substrate 12 and the sealing plate 16 (or the EL device 14), thereby enhancing the effect of retarding external components per filler 22.

The filler 22 is not limited to the bowl shown in part (a) of FIG. 2 obtained by equally dividing the hollow sphere 24 into two, but may be a bowl having a shallower bottom with a smaller curvature or a bowl having a thicker bottom with a larger curvature. The hollow sphere 24 pulverized by a roller can also be used as the filler 22, which yields a sharper cut section instead of the flat edge 22b shown in part (a) of FIG. 2.

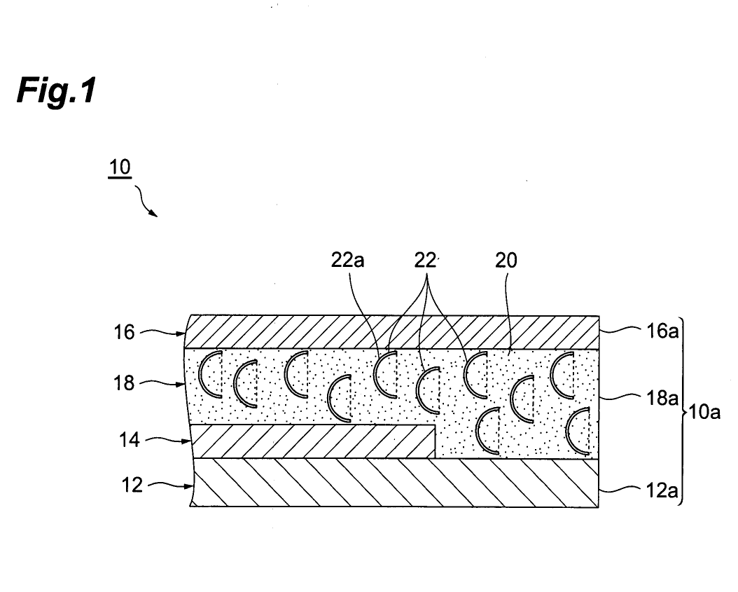

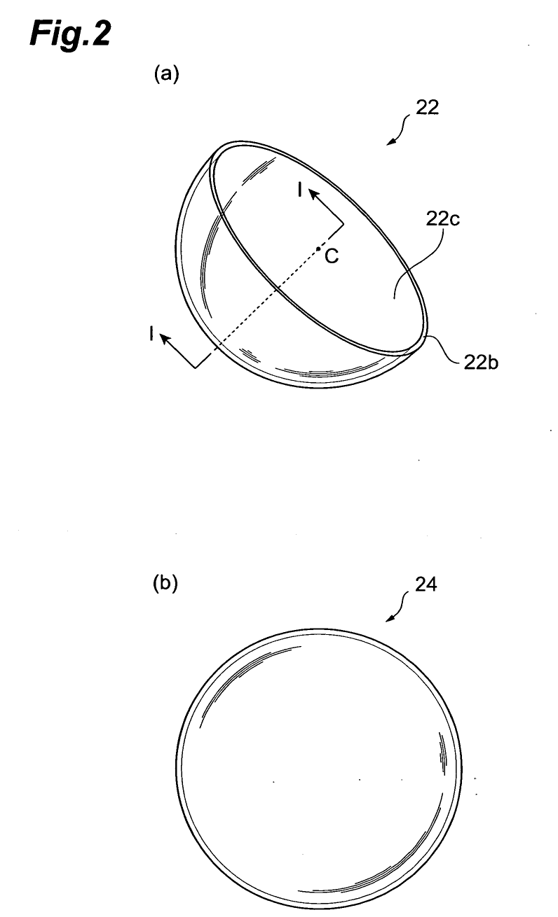

Though FIG. 1 shows the EL panel 10 in which all the fillers 22 face the end face 10a side of the EL panel, a mode in which a part of the fillers contained in the adhesive 18 face the end face 10a also realizes a longer life of the EL panel, since at least the fillers 22 facing the end face 10a contribute to the above-mentioned path extension.

### Second Embodiment

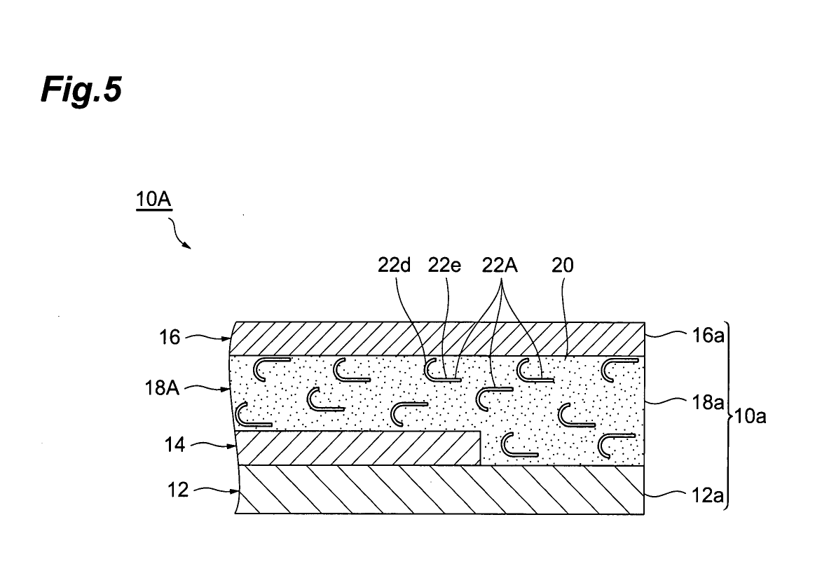

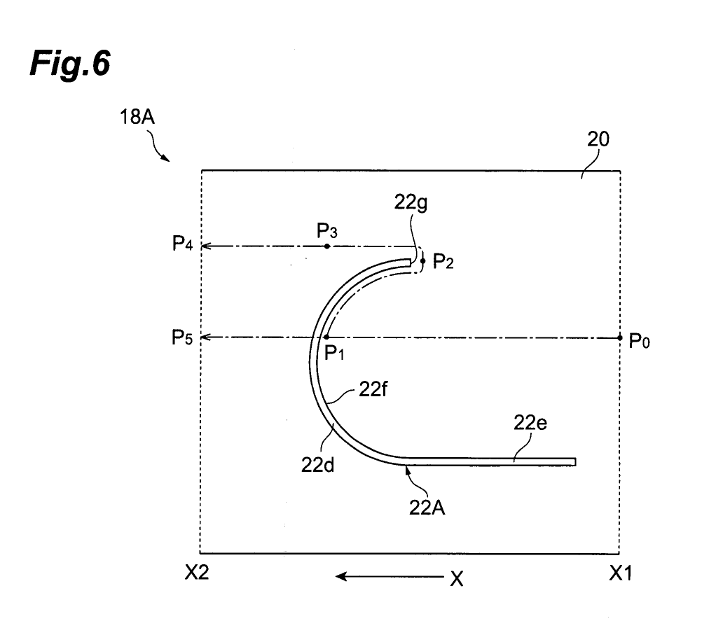

An EL panel 10A in accordance with a second embodiment of the present invention will now be explained with reference to FIGS. 5 and 6.

The EL panel 10A shown in FIG. 5 is the same as the EL panel 10 in accordance with the first embodiment except for fillers 22A contained in an adhesive 18A. Namely, the fillers 22A used in the EL panel 10A each have a non-closed shape cross section constructed by a curved part 22d and a flat part 22e, which is different from the filler 22 whose cross section is the curved part 22a as a whole. That is, in the filler 22A, a part of its cross section is the curved part 22d. Therefore, the filler 22A is formed such as to have a part of a spherical shell.

A mechanism by which the filler 22A intercepts an external component will now be explained. As shown in FIG. 6, the external component advancing in the X direction from a point P₀ of a position X1 reaches a point P₁ in contact with the filler 22A. At the point P₁, the external composition changes its advancing direction from the X direction to a direction extending to an edge 22g along the inner curved surface 22f of the curved part 22d of the filler 22A in order to bypass the filler 22A. Upon arriving at the point P₂ of the edge 22g, the external component changes its advancing direction to the X direction again, thereby progressing toward a point P₄ of a position X2. Namely, when bypassing the filler 22A, the external component moves in a retracting direction (or a direction neither advancing nor retracting) in terms of the X direction as with when bypassing the filler 22 in the first embodiment. Then, the external component is directed from the point P₂ to point P₄ while passing a point P₃ which is located at the same position as the point P₁ in terms of the X direction.

Therefore, the adhesive 18A added the filler 22A extends the path of the external component by the length of P₁-P₃ by way of the point P₂ as compared with the case without the filler 22A (i.e., the case where the external component advances straightforward from the point P₀ of the position X1 to a point P₅ of the position X2) as in the above-mentioned embodiment (adhesive 18), thereby greatly elongating the path of external components as compared with the prior art. Consequently, the adhesive 18A can retard the advance of external components more in the resin 20, thereby sufficiently elongating the life of the EL panel 10A.

### Third Embodiment

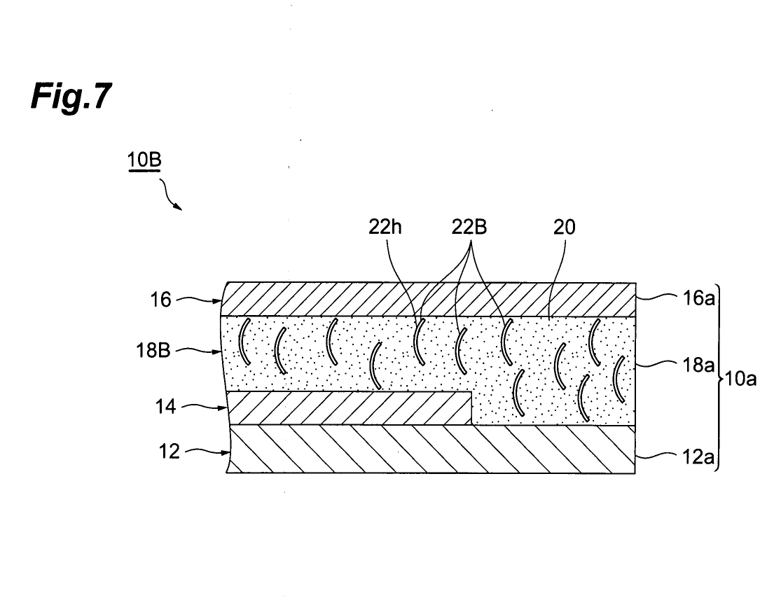

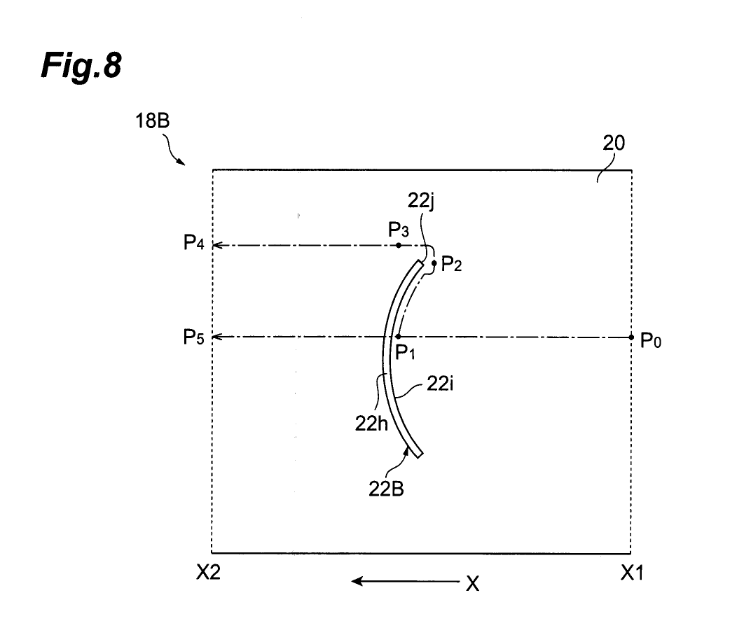

An EL panel 10B in accordance with a third embodiment of the present invention will now be explained with reference to FIGS. 7 and 8.

The EL panel 10B shown in FIG. 7 is the same as the EL panel 10 in accordance with the first embodiment except for fillers 22B contained in the adhesive 18B. Namely, the fillers 22B used in the EL panel 10B are each constructed by a substantially bowl-shaped eggshell, whose cross section forms a non-closed shape as a whole including a curved part 22h. The adhesive 18B is obtained by pulverizing an eggshell (spherical shell) with a roll and then dispersing the pulverized eggshells (parts of a spherical shell) into a resin with a mixer and a roll.

A mechanism by which the filler 22B intercepts an external component will now be explained. As shown in FIG. 8, the external component advancing in the X direction from a point P₀ of a position X1 reaches a point P₁ in contact with the filler 22B. At the point P₁, the external composition changes its advancing direction from the X direction to a direction extending to an edge 22j along the inner curved surface 22i of the filler 22B in order to bypass the filler 22B. Upon arriving at the point P₂ of the edge 22j, the external component changes its advancing direction to the X direction again, thereby progressing toward a point P₄ of a position X2. Namely, when bypassing the filler 22B, the external component moves in a retracting direction (or a direction neither advancing nor retracting) in terms of the X direction as with when bypassing the filler 22 in the first embodiment. Then, the external component is directed from the point P₂ to point P₄ while passing a point P₃ which is located at the same position as the point P₁ in terms of the X direction.

Therefore, the adhesive 18B added the filler 22B extends the path of the external component by the length of P₁-P₃ by way of the point P₂ as compared with the case without the filler 22B (i.e., the case where the external component advances straightforward from the point P₀ of position X1 to a point P₅ of the position X2) as in the above-mentioned embodiments (adhesives 18, 18A), thereby greatly elongating the path of external components as compared with the prior art. Consequently, the adhesive 18B can retard the advance of external components more in the resin 20, thereby sufficiently elongating the life of the EL panel 10B.

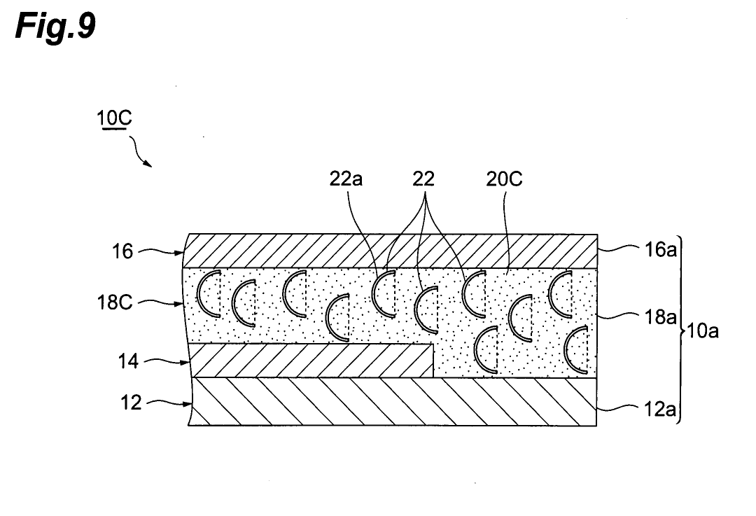

The above-mentioned first to third embodiments can also be modified as follows. Namely, as in an EL panel 10C shown in FIG. 9, a resin sheet 18C may be used in place of the adhesives (18, 18A, 18B). The resin sheet 18C is constituted by a sheet-shaped resin 20C added fillers (22, 22A, 22B). Such a resin sheet 18C can also exhibit effects similar to those of the above-mentioned adhesives (18, 18A, 18B), whereby the EL panel 10C can realize a sufficiently longer life.

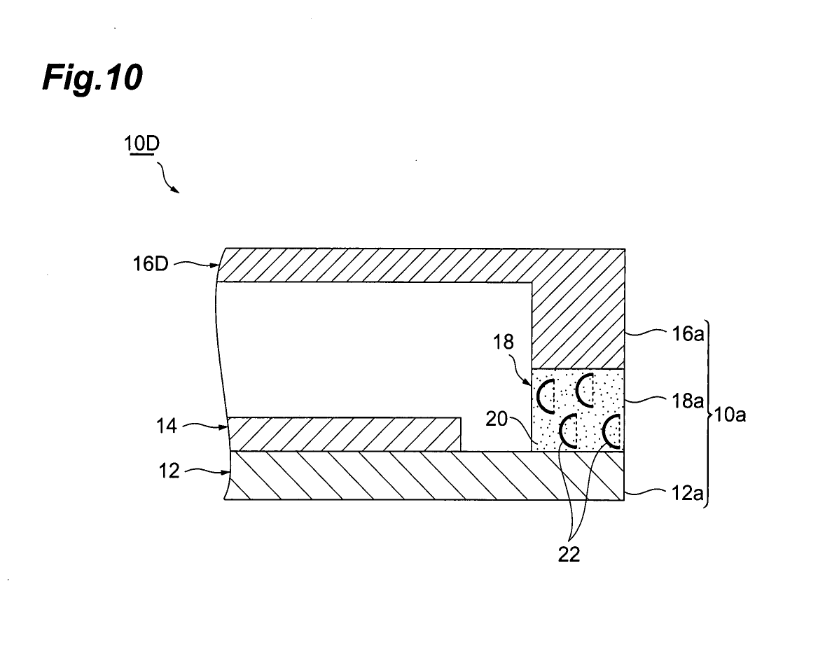

Each of the above-mentioned first to third embodiments shows a solid-sealed EL panel structure in which the gap between the substrate 12 and sealing plate 16 is filled with a resin, so as to yield an adhesive layer. However, a region including the EL device 14 between the substrate 12 and sealing plate 16 may be made hollow as appropriate, so as to yield a gas-sealed (hollow) EL panel structure. Namely, as shown in FIG. 10, the above-mentioned adhesive 18 (or the adhesive 18A, 18B or resin sheet 18C) may be used as an adhesive for bonding outer edges of the substrate 12 and sealing plate 16D of a hollow EL panel 10D. This also retards the advance of external components in the resin 20 in the adhesive 18, thereby elongating the time elapsing before the external components enter the space inside the EL panel 10D, so that the EL panel 10D realizes a sufficiently longer life.

The curved parts 22a, 22d, 22h may be not only partly but also wholly shaped like a bowl.

### EXAMPLES

The present invention will now be explained with reference to examples.

As an example, the inventors prepared an EL panel (sample #1) using an adhesive added the same fillers as the above-mentioned fillers 22. As comparative examples, an EL panel (sample #2) using an adhesive added no fillers, an EL panel (sample #3) using an adhesive added with conventional laminar fillers, and an EL panel (sample #4) using an adhesive added with the same fillers as the hollow sphere 24 were prepared.

An epoxy resin was used as the resin for the adhesive in each of the samples #1 to #4. For the hollow spheres employed in the samples #1 and #4, glass bubbles (having an average particle size of 50 μm) made of inorganic glass (soda-lime-borosilicate glass) were used. The glass bubbles were dispersed into the epoxy resin with a mixer and a roll after being pulverized with a roll in the sample #1 and as they were in the sample #4. The laminar fillers employed in the sample #3 were made by peeling a laminar clay compound into small pieces having an average size of 5 μm (length)×3 μm (width)×2 μm (thickness). In the samples #1 to #4, the same EL device was formed on the respective substrates, while using the same glass sheet for their sealing plates.

Then, the samples #1 to #4 were driven under the same condition, and changes in luminance with time were measured in their EL panels. While applying a driving voltage of 5 V to the organic EL devices produced, the luminance of the light emitted from the sealing plate side in the forward direction was measured by a luminance meter (MCPD-7000 manufactured by Otsuka Electronics Co., Ltd.).

As a result, the luminance drop ratio after 1000 hours was lower in the sample #1 than in the other samples #2 to #4. Specifically, the respective luminance drop ratios in the samples #1 to #4 were 11%, 80%, 21%, and 25%. These results verified that the EL panel had a longer life in the sample #1 which was an example than in the samples #2 to #4 which were comparative examples.

The reason why the life of the sample #1 was remarkably longer than that of the samples #2 to #4 seems to be that the fillers added to the adhesive of the sample #1 effectively extended the path of external components, thereby greatly retarding the advance of external components in the resin.

What is claimed is:

1. An electroluminescence (EL) panel comprising:
a substrate;
an EL device formed on the substrate;
a sealing plate facing the substrate and covering the EL device on the substrate; and
a resin having a filler added interposed between the substrate and sealing plate;
wherein a predetermined cross section of the filler forms a non-closed shape including a curved part.

2. An EL panel according to claim 1, wherein the filler has a form including a part of a spherical shell.

3. An EL panel according to claim 1, wherein at least a part of the curved part of the filler is shaped like a bowl.

4. An EL panel according to claim 1, wherein the filler is shaped like a bowl.
